(19) United States
(12) Patent Application Publication
(10) Pub. No.: US 2023/0243298 A1
(43) Pub. Date: Aug. 3, 2023

(54) SOUND-ATTENUATED POWER GENERATION

(71) Applicant: STEWART & STEVENSON LLC, Houston, TX (US)

(72) Inventors: Chris Harvell, Houston, TX (US); Chad Joost, Houston, TX (US); Brian Sharp, Houston, TX (US); Paul Smith, Houston, TX (US); Eric Evezic, Houston, TX (US)

(21) Appl. No.: 18/102,876

(22) Filed: Jan. 30, 2023

Related U.S. Application Data
(60) Provisional application No. 63/304,831, filed on Jan. 31, 2022.

(51) Int. Cl. F02B 77/13; F02B 63/04

(52) U.S. Cl. CPC F02B 77/13; F02B 63/044

(57) ABSTRACT

A sound-attenuated power generation system includes an enclosure. The enclosure includes a floor, side walls, end walls, and a roof. The system includes sound damping foam panels mechanically coupled to the interior of at least one of the floor, side walls, end walls, and roof. The enclosure has an intake vent formed in the side wall; an exhaust vent formed in the side wall; and a generator positioned within the enclosure, the generator including an engine.

### CROSS-REFERENCE TO RELATED APPLICATIONS

This application is a nonprovisional application which claims priority from U.S. provisional application No. 63/304,831, filed Jan. 31, 2022, which is incorporated by reference herein in its entirety.

### TECHNICAL FIELD/FIELD OF THE DISCLOSURE

The present disclosure relates generally to power generation equipment, and specifically to sound damping for generators.

### BACKGROUND OF THE DISCLOSURE

Power generation equipment can generate large amounts of noise. Noise pollution generated by such equipment can be a hazard to personnel working nearby or others in the vicinity. Rules and regulations may limit the permissible hours of operation for the equipment or may limit the amount of time personnel may be in the vicinity of such equipment.

### SUMMARY

The present enclosure provides for a sound-attenuated power generation system. The sound-attenuated power generation system may include an enclosure. The enclosure may include a floor, side walls, end walls, and a roof. The sound-attenuated power generation system may include sound damping foam panels mechanically coupled to the interior of at least one of the floor, side walls, end walls, and roof. The sound-attenuated power generation system may include an intake vent formed in the side wall. The sound-attenuated power generation system may include an exhaust vent formed in the side wall. The sound-attenuated power generation system may include a generator positioned within the enclosure, the generator including an engine

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a perspective view of a sound-attenuated power generation system consistent with at least one embodiment of the present disclosure.

FIG. 2 is a partially transparent side view of the sound-attenuated power generation system of FIG. 1 mounted on a trailer.

FIG. 3 is a side view of the sound-attenuated power generation system of FIG. 1.

FIG. 4 is an interior view of the side wall of the sound-attenuated power generation system of FIG. 3.

FIG. 5 is a side view of the sound-attenuated power generation system of FIG. 1.

FIG. 6 is an interior view of the side wall of the sound-attenuated power generation system of FIG. 5.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

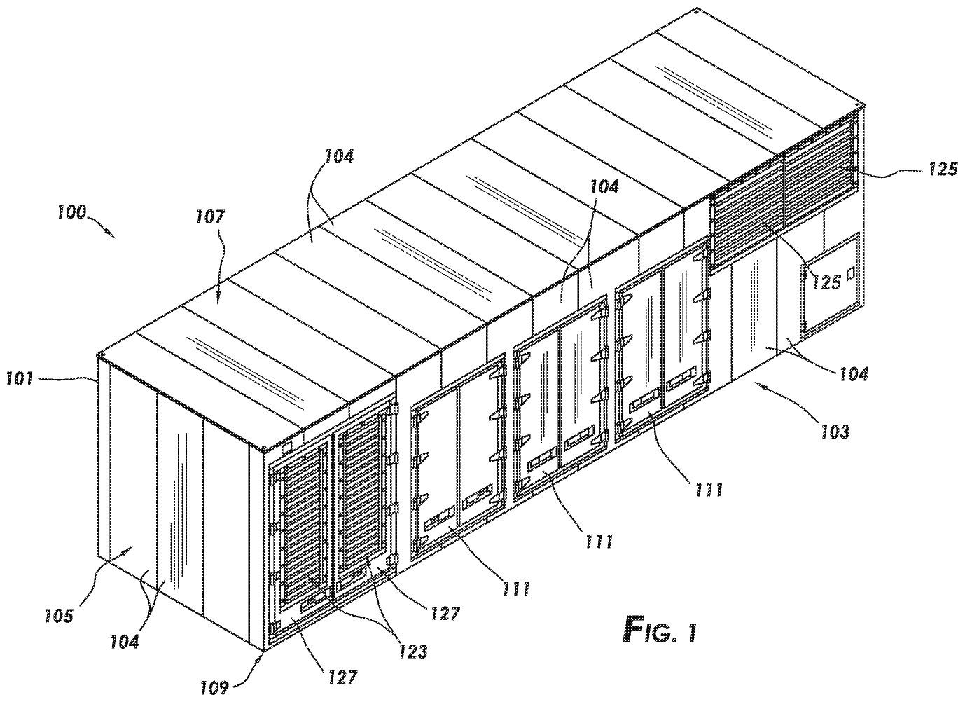

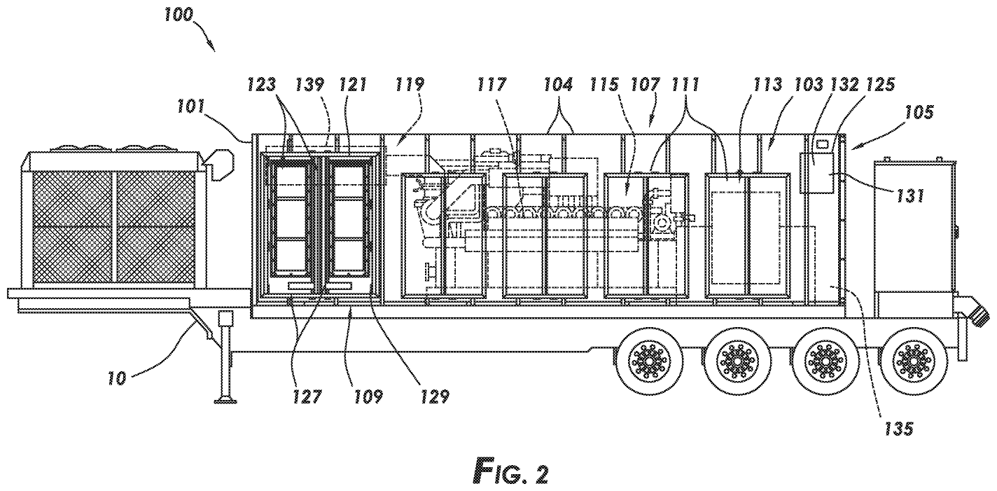

FIGS. 1-6 depict sound-attenuated power generation system 100 consistent with at least one embodiment of the present disclosure. Sound-attenuated power generation system 100 may include enclosure 101. Enclosure 101 may be formed such that sound-attenuated power generation system 100 may be transported by platform 10 as shown in FIG. 2, which may be, for example and without limitation, a skid, trailer, truck, or other mobile platform. Enclosure 101 may include side walls 103, end walls 105, roof 107, and floor 109. In some embodiments, one or more of side walls 103, end walls 105, and roof 107 may include one or more access doors 111. Access doors 111 may be positioned to allow access to the interior of enclosure 101 such as to allow for access to generator 113 positioned within enclosure 101 (shown in FIG. 2). In some embodiments, generator 113 may include engine 115. Engine 115 may be any suitable prime mover usable to run generator 113 and may include, for example and without limitation, one or more of a diesel, gasoline, or natural gas powered internal combustion, turbine, or other engine. Engine 115 may include engine block 117 and exhaust system 119. In some embodiments, exhaust system 119 may include exhaust silencer 121. Sound-attenuated power generation system 100 may be designed such that engine 115 is completely encapsulated by enclosure 101 and may operate with access doors 111 in a closed position.

In some embodiments, enclosure 101 may include one or more intake vents 123 and one or more exhaust vents 125. In some embodiments, intake vents 123 may be positioned on side walls 103. In some embodiments, intake vents 123 may be positioned on louvred doors 127. In some embodiments, louvred doors 127 may be openable to provide access to the interior of enclosure 101 but may remain closed during operation of engine 115. In other embodiments, air intake vents 123 may be positioned within enclosure 101 or may be positioned on end walls 105 or roof 107. In some embodiments, intake vents 123 may include additional device such as, for example and without limitation, a snorkel.

In some embodiments, engine 115 may be positioned within enclosure 101 such that exhaust silencer 121 of exhaust system 119 may be positioned proximate intake vents 123. In some embodiments, sound-attenuated power generation system 100 may include transformer 129 positioned within enclosure 101 adjacent intake vents 123.

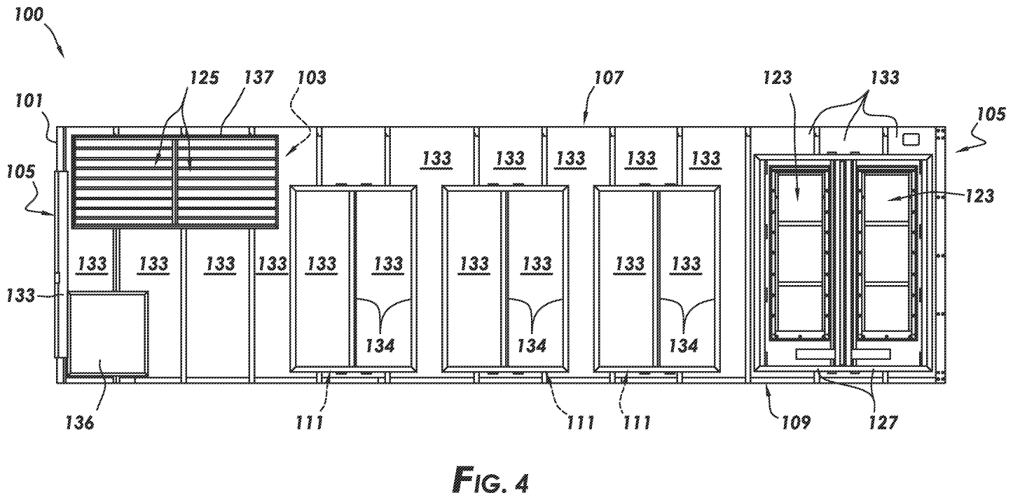

In some embodiments, exhaust vents 125 may be positioned on side walls 103 at an end of enclosure 101 opposite intake vents 123 such that air flow from intake vents 123 to exhaust vents 125 may pass across engine 115. In some embodiments, exhaust vents 125 may include exhaust fans 131. In some embodiments, exhaust fans 131 may be driven by variable-speed motors 132 (shown in FIG. 2). In some embodiments, variable-speed motors 132 may be driven by variable frequency drive (VFD) 136 (shown in FIG. 4). VFD 136 may control the speed of exhaust fans 131 and the number of exhaust fans 131 being operated such that, where possible, operation noise is reduced compared to an embodiment in which exhaust fans 131 are run continuously or at full speed. In some embodiments, VFD 136 may control the speed of exhaust fans 131 based on, for example and without limitation, one or more of ambient and inlet air temperature, ambient sound, and engine load.

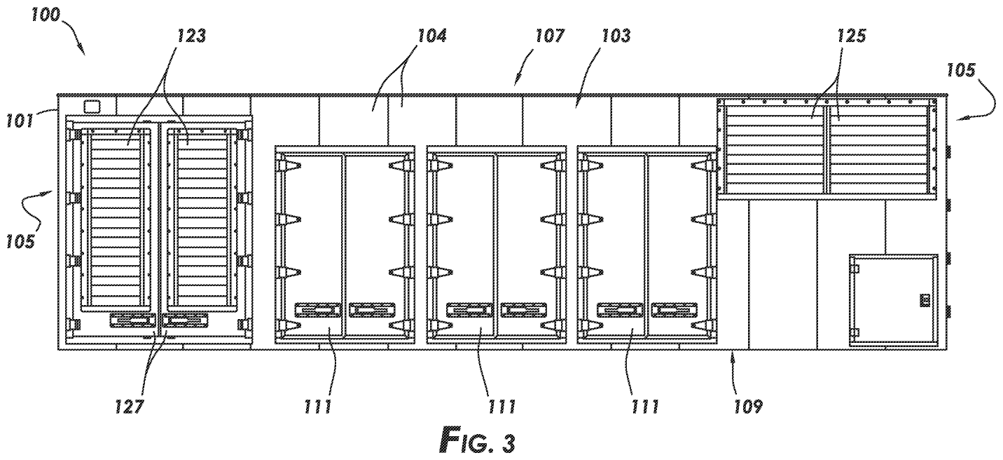

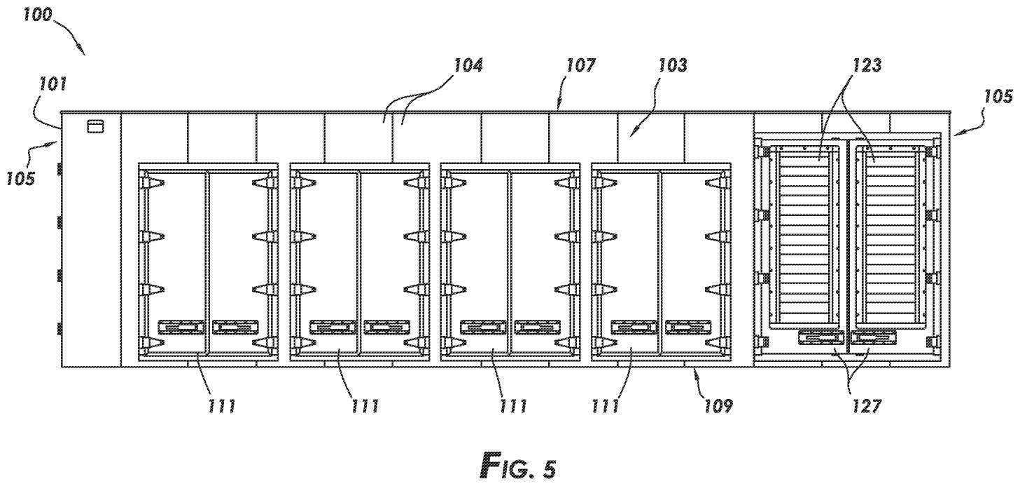

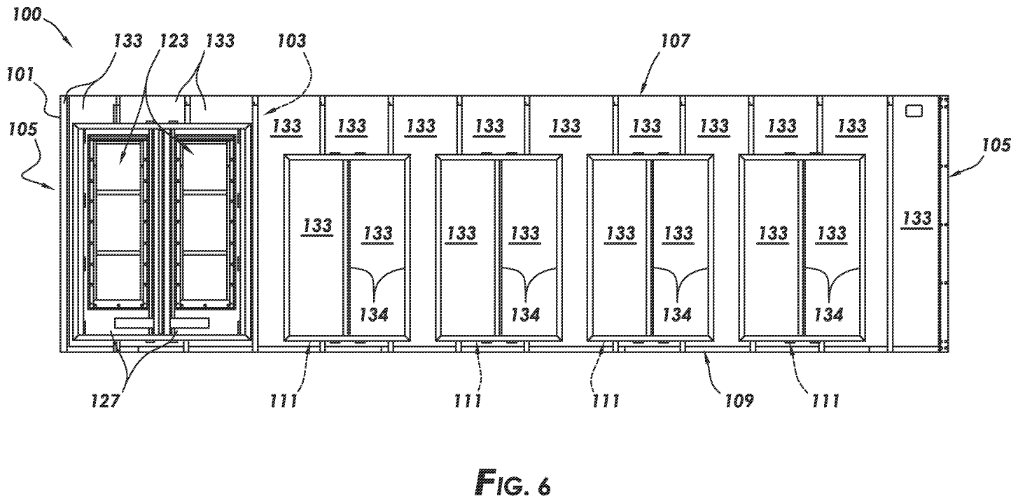

In some embodiments, sound-attenuated power generation system 100 may include one or more passive sound damping elements. For example, in some embodiments, one or more of side walls 103, end walls 105, roof 107, or floor 109 of enclosure 101 may include outer panels 104 as shown, for example and without limitation, in FIGS. 3 and 5. In some embodiments, outer panels 104 may be formed from galvanized steel, galvanneal, aluminum, carbon steel, or other rigid material such as, for example and without limitation, composite or carbon fiber. FIGS. 4 and 6 depict interior elevation views of sound-attenuated power generation system 100 showing the interiors of side walls 103.

Within side walls 103, sound-attenuated power generation system 100 may include sound damping foam panels 133 positioned adjacent outer panels 104 and access doors 111 of side walls 103. In some embodiments, sound damping foam panels 133 may also be positioned adjacent one or more of end walls 105, roof 107, or floor 109 of enclosure 101. For example and without limitation, sound damping foam panels 133 may, in some embodiments, include one or more of mass loaded vinyl panels, mineral wool, urethane faced foam, acoustical foam. Sound damping foam panels 133 may suppress and mitigate sound generated by generator 113, thereby reducing transmission of sounds generated within enclosure 101 to the surrounding environment. In some embodiments, for example and without limitation, sound damping foam panels 133 may be formed from mass loaded vinyl panels. In some embodiments, sound damping foam panels 133 may be adhered to the inner surface of outer panels 104 and access doors 111. In some embodiments, sound damping foam panels 133 may also be positioned on the inner surfaces of louvred doors 127 not taken up by intake vents 123. In some embodiments, side walls 103 may include one or more sound damping elements between outer panels 104 and access doors 111 such as, for example and without limitation, rubber weather stripping 134.

In some embodiments, with reference to FIGS. 4 and 6, intake vents 123 may be covered by sound damping intake foam panels 135. Sound damping intake foam panels 135 may be coupled to or adhered to louvred doors 127 to cover intake vents 123. Sound damping intake foam panels 135 may, for example and without limitation, reduce transmission of sounds generated within enclosure 101 to the surrounding environment through intake vents 123. Sound damping intake foam panels 135 may be formed from a material such that sound damping is achieved while allowing sufficient airflow through sound damping intake foam panels 135 to supply generator 113 such as, for example and without limitation, mass loaded vinyl, mineral wool, urethane faced foam, or acoustical foam.

In some embodiments, with reference to FIG. 4, exhaust vents 125 may be covered by sound damping exhaust foam panels 137. Sound damping exhaust foam panels 137 may be coupled to or adhered to exhaust vents 125 outside of exhaust fans 131. Sound damping exhaust foam panels 137 may, for example and without limitation, reduce transmission of sounds generated within enclosure 101 to the surrounding environment through intake vents 123. Sound damping exhaust foam panels 137 may be formed from a material such that sound damping is achieved while allowing sufficient airflow through sound damping exhaust foam panels 137 to allow sufficient airflow to generator 113 such as, for example and without limitation, mass loaded vinyl, mineral wool, urethane faced foam, or acoustical foam.

In some embodiments, sound-attenuated power generation system 100 may include one or more sound attenuating blankets 139 positioned within enclosure 101. Sound attenuating blankets 139 may, for example and without limitation, damp sound produced by equipment covered by sound attenuating blankets 139 while assisting with thermal mitigation. In some embodiments, sound attenuating blankets 139 may be formed at least partially from mass loaded vinyl. In some embodiments, sound attenuating blankets 139 may be, for example and without limitation, positioned around exhaust silencer 121, hung from roof 107, positioned at access doors 111 or louvred doors 127.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A sound-attenuated power generation system comprising:
an enclosure, the enclosure including a floor, side walls, end walls, and a roof;
sound damping foam panels mechanically coupled to the interior of at least one of the floor, side walls, end walls, and roof;
an intake vent formed in the side wall;
an exhaust vent formed in the side wall; and
a generator positioned within the enclosure, the generator including an engine.

2. The sound-attenuated power generation system of claim 1, wherein the enclosure comprises an access door positioned in the side wall, wherein the access door comprises a sound damping foam panel mechanically coupled to the interior surface of the access door.

3. The sound-attenuated power generation system of claim 1, wherein the intake vent is positioned on a louvred door positioned in the sidewall.

4. The sound-attenuated power generation system of claim 3, further comprising a sound damping intake foam panel mechanically coupled to the interior surface of the louvred door.

5. The sound-attenuated power generation system of claim 1, further comprising an exhaust fan positioned at the exhaust vent.

6. The sound-attenuated power generation system of claim 5, wherein the exhaust fan is driven by a variable-speed motor.

7. The sound-attenuated power generation system of claim 6, wherein the variable-speed motor is driven by a variable frequency drive.

8. The sound-attenuated power generation system of claim 6, further comprising a sound damping exhaust foam panel mechanically coupled to the exhaust vent.
